(19) United States
(12) Patent Application Publication
(10) Pub. No.: US 2021/0315199 A1
(43) Pub. Date: Oct. 14, 2021

(54) CRYOPRESERVATION MEDIUM FOR UMBILICAL CORD MSCS DERIVED FROM WHARTON'S JELLY

(71) Applicant: Predictive Technology Group, Inc., Salt Lake City, UT (US)

(72) Inventor: Douglas I. Schmid, Sandy, UT (US)

(21) Appl. No.: 17/267,545

(22) PCT Filed: Aug. 12, 2019
(86) PCT No.: PCT/US19/46193

§ 371 Date: Feb. 10, 2021

Related U.S. Application Data
(60) Provisional application No. 62/717,525, filed on Aug. 10, 2018.

(51) Int. Cl. A01N 1/02

(52) U.S. Cl. CPC A01N 1/0221

(57) ABSTRACT

Disclosed herein are compositions, methods, and systems for enhancing survival of mammalian cells frozen at low temperatures. In many embodiments, the cells may include stem cells that may survive at an enhanced rate relative to other cells. In some embodiments, the compositions may include Wharton's Jelly, and may optionally include DMSO and albumin, for example human serum albumin. However, in various embodiments, the disclosed compositions comprising Wharton's Jelly may eliminate or reduce the need for traditional cryopreservatives. In some embodiments, the disclosed compositions, methods, and systems may preferentially enhance survival of stem cells, for example mesenchymal stem cells. In some embodiments, the cells may be derived from umbilical cord tissue, for example Wharton's Jelly.

### CROSS-REFERENCE TO RELATED APPLICATIONS

This application claims priority to U.S. Provisional Patent Application No. 62/717,525, filed Aug. 10, 2018, entitled “CRYOPRESERVATION MEDIUM FOR UMBILICAL CORD MSCS DERIVED FROM WHARTON'S JELLY,” which is incorporated by reference herein, in the entirety and for all purposes.

### BACKGROUND

Mammalian cells may be preserved by freezing and storing them at very low temperatures, a process referred to as “cryopreservation.” This process has two goals—to maintain (1) the integrity of the cells' structure and characteristics, and (2) the cells' viability. Cells, and most media, are predominantly water. Water forms crystals at low temperatures, and crystal formation can significantly deform the cells' structure (including internal structures and organelles), and can greatly reduce a cell's viability upon thawing. Cryopreservation, therefore, is a method of freezing and maintaining cells at low temperature, while preserving the cells' characteristics and viability over long periods of time.

Cryopreservation of cells has provided a means to maintain cellular viability for extended periods (up to many years). This has allowed researchers to access the same precious cells for testing or therapy over those long periods of time, enhancing the reproducibility and predictability of cellular studies.

Cryopreservation techniques and agents have recently undergone many changes, especially as cells become more widely used in therapeutic compositions. Dimethylsulfoxide (DMSO), for example has long been used as a cryopreservant. In most cases, DMSO is used in conjunction with a protein carrier such as serum or albumin. Although animal serum is traditionally used in academic settings, because of its low cost and ready availability, use of animal serum in therapeutic products, especially those destined for human use, raises significant regulatory concerns.

Recent work has attempted to substitute synthetic and chemical agents for the DMSO and serum used in most common cryopreservation media. However, these substitute ingredients have not been tested and proven for use in human subjects.

Cryopreservation is especially important for preserving the integrity and viability of stem cells. As identifying and isolating stem cells from various sources has become more common, their use in various therapies has expanded. Unfortunately, stem cells make up a small portion of the total cells in most biological sources. Thus, it is important to maintain the viability of these cells, while maintaining the characteristics that make them valuable as therapeutics. Unfortunately, some agents used in cryopreservation may reduce the viability of stem cells or alter their ability to act as stem cells.

Providing cryo-agents and methods that maintain cellular viability and cellular characteristics without increasing risk to human subjects would be useful in developing live cell therapeutic compounds, including allografts, for human use. What is needed, therefore, are new methods and compositions that enhance the viability of stem cells while preserving their valuable characteristics.

### SUMMARY

Disclosed herein are cryopreservation methods and media comprising various combinations and concentrations of DMSO and Human Serum Albumin, combined with naturally-derived Wharton's Jelly that unexpectedly increase viability of all cells, especially stem cells. The disclosed methods and compositions may be useful in cases where traditional cryopreservatives, such as DMSO, may be toxic or harmful to the cells being frozen and preserved, may reduce viability of the cells, alter the phenotype of the cells (for example stemness), or where the traditional compositions are not able to be removed (for example where cell compositions, including cryopreservatives, are injected into a patient), or are difficult to remove after thawing.

Wharton's Jelly is a biological matrix, rich in collagen and glucosaminoglycans, found in umbilical cords. Wharton's Jelly can be extracted by enzymatic or mechanical methods. The jelly includes various cell types, mucopolysaccharides, proteins, glycoproteins, growth factors, cytokines, etc. Depending upon the method used to obtain it, Wharton's Jelly can include epithelial cells, epidermal cells, fibroblasts, immune cells, and stem cells. For example, Wharton's Jelly can be a rich source of mesenchymal stem cells. In some cases, Wharton's Jelly may contain up to 20% MSC.

Applicants have discovered that traditional cryopreservatives can be replaced and/or their concentrations reduced by replacing them with Wharton's Jelly. Unexpectedly, Applicants disclose that replacement and/or reduction of those traditional cryopreservatives results in significant increases in post-thaw viability of cells stored in Applicant's cryopreservation solution. This enhanced viability is especially large for stem cells, especially MSCs derived from Wharton's Jelly. In some embodiments, the disclosed cryopreservative compositions and methods may allow for maintaining viability while avoiding traditional agents that may be undesirable.

Disclosed herein is a composition for use in cryopreservation of mammalian cells that comprises Wharton's Jelly and reduced amounts, compared to typical cryopreservative compositions, of DMSO and/or albumin.

Disclosed herein is a method of preserving mammalian cells at very low temperatures, the method comprising the steps of, isolating Wharton's Jelly from an umbilical cord, combining the Wharton's Jelly DMSO to a final concentration of between 0% and 30%, combining the Wharton's Jelly with serum albumin to a final concentration of between 0% and 10%, and creating a composition comprising a total population of mammalian cells, DMSO, albumin, and Wharton's Jelly. In many embodiments, the total population of mammalian cells includes a population of mesenchymal stem cells. The disclosed method may allow for survival of the population of mesenchymal stem cells at a greater rate than the survival of the total population of mammalian cells.

Disclosed herein is a method of making a cryopreservative, the method comprising the steps of: removing blood vessels from an umbilical cord, increasing the surface area of the umbilical cord to create an umbilical cord composition; combining the umbilical cord composition with about 1× to about 20× (gram to ml) of saline (for example about 5×), mixing the umbilical cord composition and saline to create a mixture; passing the mixture through at least one filter, wherein the filter has a pore size of 100 μm or less. In some embodiments, the filtered mixture may further be combined with one or more of DMSO and albumin.

### BRIEF DESCRIPTION OF THE DRAWINGS

FIG. 1 is a bar graph comparing survival of MSCs in cryopreservatives with and without Wharton's Jelly.

FIG. 2 is a bar graph comparing % MSC, after thawing, of various cryopreservative formulations with Wharton's Jelly and DMSO at 0%, 2.5%, 5%, and 10%. The concentration of cells was also varied from 2.5×10\hat{ }6 to 10×10\hat{ }6 cells/ml.

FIG. 3 is a bar graph of the experiment shown in FIG. 2, with absolute live MSC numbers.

FIG. 4 is two bar graphs showing effect of filtering Wharton's Jelly through various average pore sizes.

### DETAILED DESCRIPTION

Disclosed herein are compositions, methods, and systems for enhancing survival of cells after freezing. In some embodiments, the compositions and methods allow for reduction or elimination of traditional cryopreservatives such as dimethyl sulfoxide (DMSO) and albumin.

### Wharton's Jelly

Wharton's Jelly, as described herein may be obtained from mammalian umbilical cords using a variety of methods. In one embodiment the method includes disruption of the umbilical cord tissue using a process selected from one or more of chemical, enzymatic, or mechanical disruption. In methods using mechanical disruption, the umbilical cord may have one or more blood vessels removed prior to mechanical disruption. In these methods, the mechanical disruption may include reducing the solid tissue of the umbilical cord into individual pieces having a weight of between about 0.1 to about 10 grams. The umbilical cord tissue pieces may be combined with an amount of saline, at a ratio of grams tissue:milliliters saline of from about 1:100 to about 1:2, in one preferred embodiment 1 gram of tissue is combined with 5 ml of saline (i.e. 1:5). In most embodiments, the saline is a solution of NaCl of between 0.1 and 23%, in one embodiment, the saline is about a 0.9% solution. In many embodiments the Wharton's Jelly may be separated from solid tissue and other larger pieces of umbilical cord by filtering, through for example a filter of at least about 100 μm pore size filter. In some embodiments, the Wharton's Jelly may be filtered through a filter having a pore size less than about 100 μm, 95 μm, 90 μm, 85 μm, 80 μm, 75 μm, 70 μm, 65 μm, 60 μm, 55 μm, 50 μm, 45 μm, 40 μm, 35 μm, 30 μm, 25 μm, 20 μm, 15 μm, 10 μm, or 5 μm, and greater than about 1 μm, 5 μm, 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, or 95 μm.

The Wharton's Jelly may comprise one or more mammalian cells, proteins, peptides, and extracellular matrix. In many embodiments, the Wharton's Jelly comprises a population of MSCs at a concentration of between about 0.1 and 20×10\hat{ }6 cells/ml. In many embodiments, the Wharton's Jelly may comprise about 5-40% MSCs of the total population of cells, in most embodiments the amount of MSCs in Wharton's Jelly, relative to all the cells, is about 20%. In many embodiments, the MSCs may include one or more surface markers selected from CD90, CD73, and CD105. In some embodiments, the population of MSCs may be negative for one or more surface markers selected from CD11, CD14, CD19, CD34, CD45, and HLA-DR. A population of cells may be positive for a specific marker if between about 30% and 100% of the cells express the marker, for example greater than about 30%, 35%, 40%, 45%, 50%, 55%, 60%, 65%, 70%, 75%, 80%, 85%, 90%, or 95%, and less than about 100%, 95%, 90%, 85%, 80%, 75%, 70%, 65%, 60%, 55%, 50%, 45%, 40%, or 35%. A population of cells may be negative for a specific marker if between about 70% and 0% of the cells express the marker, for example less than about 70%, 65%, 60%, 55%, 50%, 45%, 40%, 35%, 30%, 25%, 20%, 15%, 10%, or 5%, and greater than about 0%, 5%, 10%, 15%, 20%, 25%, 30%, 35%, 40%, 45%, 50%, 55%, 60%, or 65%. In most embodiments, a positive marker is expressed by more than 80% of the population and a negative marker is expressed by less than about 20% of the population. In some embodiments, a cell that is negative for a given marker, may have a level of staining that is above zero, but less than what is deemed the level of background for a given cell with a given marker.

The disclosed cryopreservation compositions may include DMSO. In some embodiments, the cryopreservation compositions may comprise DMSO at a final concentration of between about 0% and 30% DMSO, for example greater than about 0%, 0.1%, 0.2%, 0.3%, 0.4%, 0.5%, 0.6%, 0.7%, 0.8%, 0.9%, 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, or 25%, and less than about 30%, 25%, 24%, 23%, 22%, 21%, 20%, 19%, 18%, 17%, 16%, 15%, 14%, 13%, 12%, 11%, 10%, 9%, 8%, 7%, 6%, 5%, 4%, 3%, 2%, 1%, 0.9%, 0.8%, 0.7%, 0.6%, 0.5%, 0.3%, 0.4%, 0.2%, or 0.1%. In a preferred embodiment, the final concentration of DMSO may be about 10%. In other embodiments, the disclosed cryopreservation composition does not include DMSO, for example where DMSO may be toxic or poorly tolerated by the cells being cryopreserved. In other cases, the disclosed compositions and methods, may allow for reduction of the concentration of one or more traditional cryopreservatives that may be poorly tolerated, by the cells being frozen, at higher temperatures.

The disclosed cryopreservation compositions may include added albumin. In most embodiments, the added albumin may be human serum albumin. In many embodiments the cryopreservation compositions may comprise added albumin at a final concentration of between about 0.1 and 10%, for example greater than about 0.1%, 0.2%, 0.3%, 0.4%, 0.5%, 0.6%, 0.7%, 0.8%, 0.9%, 1.0%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5%, 3.0%, 3.5%, 4.0%, 4.5%, 5.0%, 6.0%, 7.0%, 8.0%, or 9.0%, and less than about 10%, 9.0%, 8.0%, 7.0%, 6.0%, 5.5%, 5.0%, 4.5%, 4.0%, 3.5%, 3.0%, 2.5%, 2.4%, 2.3%, 2.2%, 2.1%, 2.0%, 1.9%, 1.8%, 1.7%, 1.6%, 1.5%, 1.4%, 1.3%, 1.2%, 1.1%, 1.0%, 0.9%, 0.8%, 0.7%, 0.6%, 0.5%, 0.4%, 0.3%, 0.2%, or 0.1%. In a preferred embodiment, the final concentration of added albumin may be about 2.5%. In some embodiments, the cryopreservative composition may not include added albumin.

### Stem Cells

Disclosed herein are compositions, methods, and systems for preserving mammalian cells. In many embodiments, the mammalian cells are stem cells. In some embodiments, the stem cells are mesenchymal stem cells. In some embodiments, the cells are derived from umbilical cord tissue, for example Wharton's Jelly. In other embodiments, the cells may be any type of cell derived from mammalian tissue, for example mesenchyme, adipose, endothelial, dental, neural, bone, immune, heart, liver, kidney, lung, hematopoietic, etc. In some embodiments, the cells may be therapeutic cells, and may be intended to be administered to a patient in need of treatment with a live cell. In other embodiments, the cells may be for research purposes, or the cells may produce a factor or protein, such as an antibody, growth factor, etc.

### Cryotemperatures

The disclosed compositions, processes, and systems may be useful for freezing and maintaining mammalian cells at very low, or cryogenic, temperatures. In some embodiments, the temperatures may be less than about −40° C., −50° C., −60° C., −70° C., −80° C., −90° C., −100° C., −110° C., −120° C., or −130° C., and greater than −140° C., −130° C., −120° C., −110° C., −100° C., −90° C., −80° C., −70° C., −60° C., or −50° C. The cells may be maintained for more than 24 h, 36 h, 48 h, 72 h, 4 days, 5 days, 7 days, 8 days, 9 days, 10 days, 11 days, 12 days, 13 days, 14 days, 1 month, 2 months, 3 months, 4 months, 5 months, 6 months, 7 months, 8 months, 9 months, 10 months, 12 months, 13 months, 14 months, 15 months, 16 months, 17 months, 18 months, 24 months, 36 months, 48 months, or 60 months, and less than about 120 months, 60 months, 48 months, 36 months, 24 months, 12 months, 11 months, 10 months, 9 months, 8 months, 7, months, 6 months, 5 months, 4 months, 3 months, 2 months, 1 months, 3 weeks, 2 weeks, 1 week, 6 days, 5 days, 4 days, or 3 days.

### Cellular Therapeutic Compositions

The disclosed methods and compositions may be useful in creating a cellular therapeutic composition. In some embodiments, the disclosed cryopreservatives may be directly injected into a subject, without the need to isolate cells mixed with the cryopreservative. In many embodiments, for example where the cryopreservative is combined with a therapeutic stem cell to form a cellular therapeutic composition, the frozen composition may be thawed and directly transferred into a subject for treatment. In most traditional methods, the cells may need to be manipulated to remove the cryopreservative or one or more components thereof. Thus, the disclosed methods and compositions may help avoid contamination during manipulation by reducing the amount of manipulation necessary to prepare the composition for injecting into the subject.

In most embodiments disclosed, the subject may be a human, and the composition may include human cells, for example stem cells and/or engineered therapeutic cells.

### EXAMPLES

### Example 1—Pre and Post-Cryopreservation

Cryopreservative was prepared with and without Wharton's Jelly. Both formulations included DMSO at about 10% final concentration. The Wharton's Jelly containing formulation included about 2.5% albumin, and the remainder a filtered mixture Wharton's Jelly and cells. The other formulation included albumin at 20% and the remainder saline and cells.

The cryopreservative compositions were mixed to suspend the cells and then frozen at −80° C. or lower. In some embodiments, the cryopreservation compositions were stored in the vapor phase of liquid nitrogen at about −135° C. for 24 h or more hours. Total and MSC cell percentages were determined by flow cytometry. MSCs were identified by having certain surface markers, and lacking others (see above).

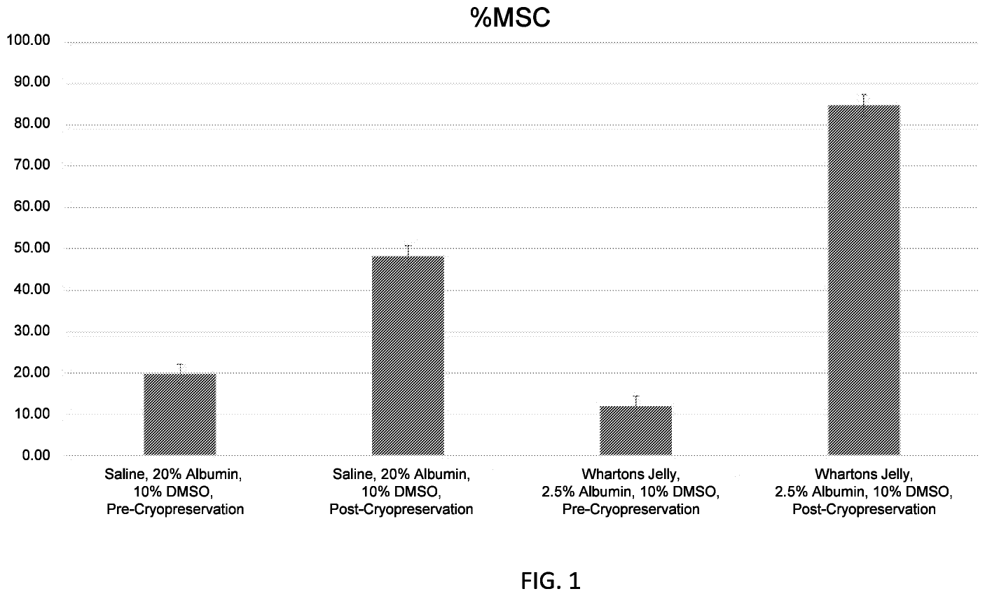

FIG. 1 shows the percentage of MSC's for both formulations, before and after cryopreservation. This bar graph shows that the percentage of MSCs in the formulation before and after cryopreservation is dramatically enhanced in the presence of Wharton's Jelly. Specifically, while the MSC percentage in the non-Wharton's Jelly formulation went from 20 to about 50%, an increase of 2.5×, the Wharton's Jelly formulation enhanced survival of MSCs 7-8X (from about 10% to greater than 80%). This was unexpected and demonstrates that freezing cells in Wharton's Jelly preferentially enhances survival of MSCs over other cell types.

### Example 2—Cell Concentration and Cryopreservation

Wharton's Jelly containing mammalian cells was prepared as described above. In these experiments, the concentration of DMSO was varied from 0 to 10% (0, 2.5, 5, and 10%), and the cell concentration was also varied from 2.5-10×10\hat{ }6 cells/ml. Cryopreservation was performed as before.

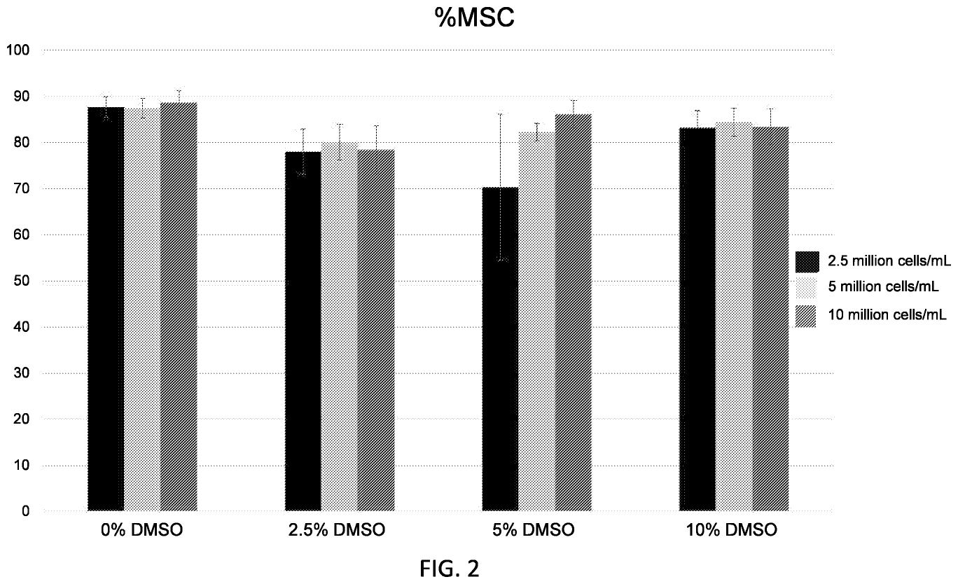

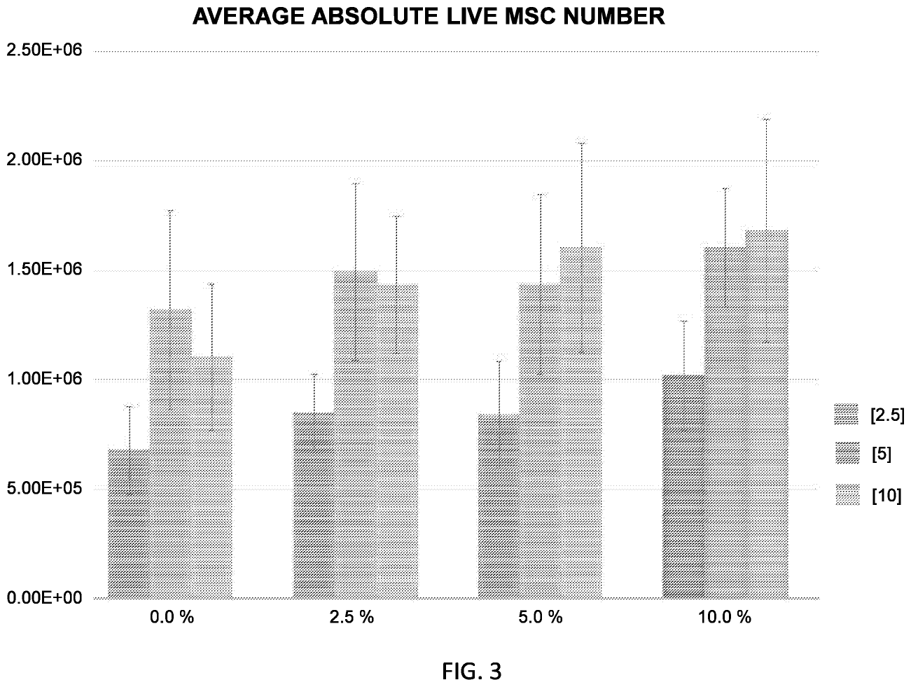

FIG. 2 shows that the percentage of MSCs post-cryopreservation was in the 70-90% range, and that formulations having 0% DMSO showed similar survival enhancement compared to formulations having 10% DMSO. The enhanced survival was also seen with the different starting cell concentrations. FIG. 3 shows average absolute live MSC number for the data in FIG. 3.

### Example 3—Filtering Wharton's Jelly

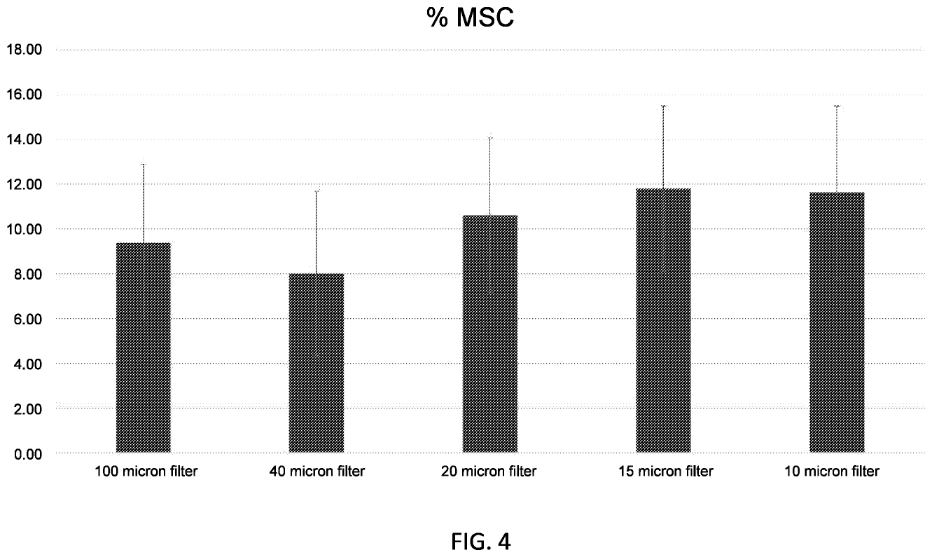

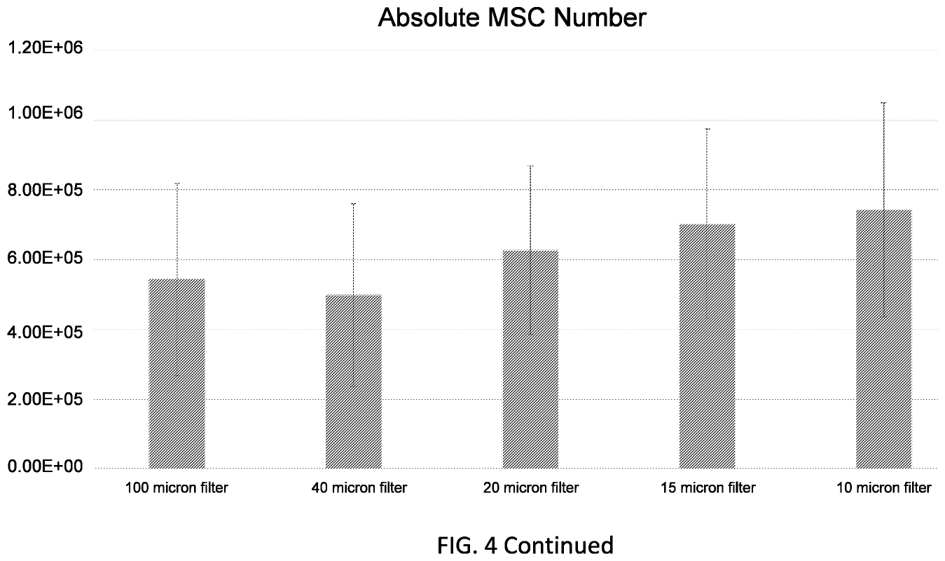

Wharton's Jelly was prepared as described above. Prior to combining with cells the Wharton's Jelly was filtered through one or more filters. FIG. 4 shows % MSC (top panel) and absolute MSC number (lower panel). On the horizontal axis are sizes of the smallest pore size filter to which the Wharton's Jelly was passed prior to combining with cells for cryopreservation.

While multiple embodiments are disclosed, still other embodiments of the present invention will become apparent to those skilled in the art from the following detailed description. As will be apparent, the invention is capable of modifications in various obvious aspects, all without departing from the spirit and scope of the present invention. Accordingly, the detailed description is to be regarded as illustrative in nature and not restrictive.

### Example 4—Comparison of Viability, CD29, CD73, CD105, and CD90 Expression

Table 1, below shows data from tests performed on various lots of cells stored under standard conditions (as described above) and conditions using the presently disclosed methods and compositions (also described above). This data demonstrates that, on average, viability and surface marker expression is at least as good as, if not better, when preserving cells under the presently disclosed methods and compositions, than with traditional methods and compositions.

TABLE I

| | | | |
|---|---|---|---|
| | | CD29, | |
| | | CD73, | |
| Lot Number | Viability | CD105 | CD90 |

Standard Cryopreservation Media

| | | | |
|---|---|---|---|
| 1160 | 72.323% | 59.071% | 48.681% |
| 7992 | 85.649% | 85.847% | 62.791% |
| B2962 | 84.553% | 32.277% | 46.761% |
| RDDJ007 | 80.398% | 36.235% | 19.979% |
| 9958 | 77.344% | 83.351% | 34.902% |
| B3457 | 92.141% | 30.262% | 18.933% |
| 9952 | 82.724% | 68.812% | 33.295% |
| 1150 | 78.505% | 18.301% | 17.571% |
| 6051 | 88.912% | 63.984% | 35.039% |
| B4000 | 88.66% | 52.424% | 37.599% |
| Average | 83.121% | 53.056% | 35.555% |
| Standard deviation | 1.82% | 6.96% | 4.35% |

Wharton's Jelly Cryopreservation Media

| | | | |
|---|---|---|---|
| 19194040-FCC | 79.86% | 56.887% | 41.425% |
| 19194048-FCC | 87.82% | 59.232% | 44.226% |
| 19194049-FCC | 85.15% | 59.082% | 51.754% |
| 19194051-FCC | 73.90% | 48.656% | 31.355% |
| 19194002-FCC | 86.56% | 51.351% | 15.942% |
| 19196003-FCC | 89.81% | 73.158% | 67.511% |
| 19197048-FCC | 91.62% | 50.305% | 21.389% |
| 19198002-FCC | 87.67% | 69.654% | 56.611% |
| Average | 85.299% | 58.541% | 41.277% |
| Standard Deviation | 1.91% | 2.95% | 5.83% |

All references disclosed herein, whether patent or non-patent, are hereby incorporated by reference as if each was included at its citation, in its entirety. In case of conflict between reference and specification, the present specification, including definitions, will control.

Although the present disclosure has been described with a certain degree of particularity, it is understood the disclosure has been made by way of example, and changes in detail or structure may be made without departing from the spirit of the disclosure as defined in the appended claims.

1. A composition for enhancing stem cell survival during cryopreservation, comprising:
Wharton's Jelly; and
saline.

2. The composition of claim 1, further comprising DMSO or albumin at a final concentration of less than about 30%,

3. The composition of claim 1, further comprising DMSA, wherein the concentration of DMSO is between about 10% and 0%.

4-5. (canceled)

6. The composition of claim 3, wherein the concentration of DMSO is less than about 1%.

7. (canceled)

8. The composition of claim 1, further comprising albumin, wherein the concentration of albumin is between about 10% and 0%.

9-10. (canceled)

11. The composition of claim 8, wherein the concentration of albumin is less than about 0.5%.

12. (canceled)

13. The composition of claim 8, wherein the albumin is human serum albumin.

14. A method of enhancing survival of a population of frozen mammalian cells, comprising the steps of:
obtaining Wharton's Jelly, derived from a mammalian umbilical cord;
combining the Wharton's Jelly and the mammalian cells to form a mixture;
freezing the mixture; and
maintaining the mixture at less than about −80° C., wherein the percentage of cells alive after the mixture thaws is greater than the percentage of cells alive for mixtures that do not contain Wharton's Jelly.

15. The method of claim 14, wherein the population of frozen cells includes a population of stem cells.

16. The method of claim 15, wherein the stem cells are human mesenchymal stem cells.

17. The method of claim 14, wherein the population of mammalian cells has an enhanced percentage of stem cells alive after thawing compared to similar cells frozen in a mixture lacking Wharton's Jelly.

18. The method of claim 14, wherein the mixture further comprises DMSO or albumin at a final concentration of between 0.1 and 10.

19-20. (canceled)

21. The method of claim 18, wherein the concentration of DMSO is less than about 2.5%.

22. The method of claim 18, wherein the concentration of DMSO is less than about 1%.

23-25. (canceled)

26. The method of claim 18, wherein the concentration of albumin is less than about 1%.

27. The method of claim 18, wherein the concentration of albumin is less than about 0.5%.

28. The method of any of claims 18-27, wherein the concentration of albumin is zero.

29. The method of claim 18, wherein the albumin is human serum albumin.

30. The method of claim 18, wherein the percentage of stem cells alive after thawing is greater than 3-times the percentage for similar stem cells frozen in a composition lacking Wharton's Jelly.

31. A method of manufacturing a cryopreservative composition, comprising the steps of:
processing a mammalian umbilical cord to obtain Wharton's Jelly from the umbilical cord;
combining the Wharton's Jelly with a saline solution to create a mixture;
passing the mixture through a filter device with a pore size less than about 100 μm;
collecting the filtered mixture, and thereby
manufacturing the cryopreservative composition.

32-34. (canceled)

35. The method of claim 32, wherein the filter device has a filter with a pore size less than about 10 μm.

36. A method of treating a mammalian subject with the cellular therapeutic composition of claim 1, the method comprising:
warming the frozen cellular therapeutic to room or about core temperature of the subject; and
injecting the warmed cellular therapeutic into the patient.

37. (canceled)
